(19) United States
(12) Patent Application Publication
(10) Pub. No.: US 2026/0087131 A1
(43) Pub. Date: Mar. 26, 2026

(54) LARGE LANGUAGE MODEL GENERATED ENDPOINT DETECTION AND RESPONSE SYSTEM

(71) Applicant: MICROSOFT TECHNOLOGY LICENSING, LLC, Redmond, WA (US)

(72) Inventors: Zheng DONG, Redmond, WA (US); Everton Luís BERZ, Taquara (BR); Jie LI, Redmond, WA (US); Patrick ESTAVILLO, Bothell, WA (US); Geoffrey Lyall MCDONALD, Vancouver (CA); Dmitri BEKERMAN, Vancouver (CA); Evan John ARGYLE, Salt Lake City, UT (US); Moukhik MISRA, Pittsburgh, PA (US)

(21) Appl. No.: 18/963,406

(22) Filed: Nov. 27, 2024

Related U.S. Application Data
(60) Provisional application No. 63/699,133, filed on Sep. 25, 2024.

(51) Int. Cl. G06F 21/55

(52) U.S. Cl. CPC G06F 21/554

(57) ABSTRACT

The disclosed configurations generate synthetic attack data that emulates the markers of a cyberattack. The generated synthetic attack data is used to train an attack detection machine learning model that detects and mitigates actual cyberattacks in real-time. Synthetic attack data is generated by a synthetic attack data generation model, which is trained with a synthetic attack data generation prompt. The synthetic attack data generation prompt is constructed out of attack data samples and a prompt guideline. The prompt guideline is created from attack procedure descriptions, such as security blog posts or other write-ups about actual cyberattacks. Prompt guidelines may include samples of actual attack data that indicate how to format synthetic attack data. Once deployed, the attack detection machine learning model infers the occurrence of a cyberattack from log entries. Detected cyberattacks may be mitigated in an automated or semi-automated manner.

### CROSS-REFERENCE TO RELATED APPLICATION

This application claims the benefit of U.S. provisional application No. 63/699,133 filed on Sep. 25, 2024, entitled “Large Language Model Generated Endpoint Detection And Response System” the entirety of which is hereby incorporated by reference herein.

### BACKGROUND

Cyberattacks are becoming more common and more sophisticated. Attackers have begun leveraging machine learning models to discover new attack vectors and to automate attacks, with a particular focus on enterprise deployments. For example, machine learning models may be used to integrate multiple distinct vulnerabilities in novel ways and in different environments. Machine learning models may also be used to reduce the time or expertise needed to construct and execute an attack. In the face of these threats, existing techniques for identifying and responding to cyberattacks, which are often based on a manual appraisal of attack telemetry data and implemented with hand-written procedural code, are increasingly inadequate.

It is with respect to these and other considerations that the disclosure made herein is presented.

### SUMMARY

The disclosed configurations generate synthetic attack data that emulates the markers of a cyberattack. The generated synthetic attack data is used to train an attack detection machine learning model that detects and mitigates actual cyberattacks in real-time. Synthetic attack data is generated by a synthetic attack data generation model, which is trained with a synthetic attack data generation prompt. The synthetic attack data generation prompt is constructed out of attack data samples and a prompt guideline. The prompt guideline is created from attack procedure descriptions, such as security blog posts or other write-ups about actual cyberattacks. Prompt guidelines may include samples of actual attack data that indicate how to format synthetic attack data. Once deployed, the attack detection machine learning model infers the occurrence of a cyberattack from log entries. Detected cyberattacks may be mitigated in an automated or semi-automated manner.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates generating synthetic attack data from attack procedure descriptions and attack data samples.

FIG. 2 illustrates training an attack detection machine learning model from synthetic attack data, real attack data, and benign action data.

FIG. 3 illustrates generating an alert based on log entries caused by a security incident.

FIG. 4 is a flow diagram of an example method for a large language model generated endpoint detection and response system.

FIG. 5 is a computer architecture diagram illustrating an illustrative computer hardware and software architecture for a computing system capable of implementing aspects of the techniques and technologies presented herein.

### DETAILED DESCRIPTION

Large language models have revolutionized how many tasks are performed. Individual productivity has increased, often significantly. However, this same technology may be used for malicious purposes. Hackers seeking to infiltrate production computing systems may utilize large language models in a number of ways. Breaking into a computing system entails a high degree of know-how, access to and familiarity with specialized tools, and an ability to identify vulnerabilities. Large language models may be used to assist attackers with these challenges by designing new attack techniques, combining new and existing techniques, and even generating code to implement an attack. The amount and type of information that a large language model (LLM) can process has the potential to greatly increase the number and type of attacks. Another advantage of LLM-based attack generation systems is avoiding the bias of a specific hacker, expanding the types of attacks beyond current trends. Automation of LLM-based systems may also significantly increase the breadth and persistence of cybersecurity attacks.

For example, an attacker who has access to a command line of a target computing device may want to launch a browser tab. It may take an individual a number of hours before identifying an attack vector to accomplish this goal. An LLM-based system, in contrast, may process vast amounts of online information to generate example code for achieving this goal in a matter of minutes.

An LLM-based system may be even more useful for more challenging tasks. For example, initially breaking into an enterprise system may be difficult even for an experienced attacker. Using an LLM-based system the attacker may generate phishing campaigns, explore vulnerabilities, etc., much faster than a human acting alone.

Endpoint Detection and Response (EDR) is a critical component of modern cybersecurity, as it provides protection against advanced threats to computing endpoints. However, EDR faces several challenges, such as the high cost and complexity of collecting and analyzing large volumes of endpoint telemetry, which leads to inadequate detection coverage. Due to the scarcity of attack examples, previous EDR systems relied largely on prior attack incidents for the creation of heuristic detections and/or machine learning features. This technique is inherently reactive, leading to increased downtime and allowing hackers greater access to compromised endpoints.

To address the lack of attack examples, machine learning models are leveraged to synthesize attack data that imitates data generated by a cyberattack. Machine learning models such as large language models are leveraged to create realistic and diverse synthetic attack data. For example, a synthetic attack data generation model may be used to generate event log entries of actions that would be taken by a cyberattack.

Synthetic attack data may be used to train attack detection machine learning models or to generate heuristic detection logic for EDR systems. Model-generated synthetic attack data may also be analyzed by security engineers to identify novel attack vectors. Identifying threats before they are encountered in production systems allows security software to identify and remediate threats sooner. Using model-generated synthetic attack data also reduces the amount of manual analysis needed to detect attacks among benign user actions. As referred to herein, a benign user action refers to a user action that does not compromise, harm, or otherwise maliciously use a computing device.

In some configurations, model-generated synthetic attack data may be combined with attack data generated from real-world attacks. To learn to identify when attacks are not taking place, benign endpoint data from benign endpoint usage may also be included. This assortment of training data may be used to train machine learning models or to fine-tune existing LLMs to detect attacks. The combination of synthetic attack data with real attack data and benign action data has been shown to increase the effectiveness of the resulting attack detection models.

Some security software is designed to protect against a broad range of attacks. Other types of security software have a well defined but narrow scope, protecting against specific types of attacks. For example, a security system, or a component thereof, may be directed at preventing network attacks, command line based attacks, or file system attacks, etc. In some configurations, comprehensive security software is designed by combining multiple specialized security components. Specializing on particular types of attacks has been shown to reduce the number of false negatives identified.

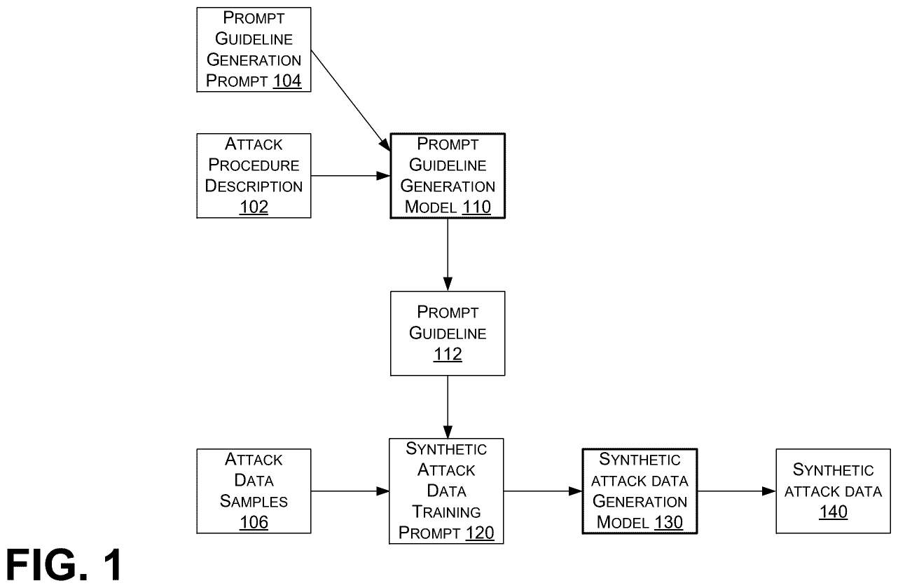

FIG. 1 illustrates generating synthetic attack data from attack procedure descriptions and attack data samples. Attack procedure descriptions 102 are descriptions of cyberattacks. Attack procedure descriptions 102 may include natural language descriptions and/or formal descriptions of cyberattacks. One example of an attack procedure is: “Wizard Spider has used macros to execute PowerShell scripts to download malware on victim's machines. It has also used PowerShell to execute commands and move laterally through a victim network.”

Attack procedure descriptions 102 may be obtained from an online repository of known attack techniques, such as the MITRE ATT&CK knowledge base. Attack procedure descriptions 102 may be selected to tailor generated synthetic attack data 140. Attack procedure descriptions 102 may be selected for being associated with a particular type of attack such as a denial-of-service attack or privilege escalation. Attack procedure descriptions 102 may also be selected for being associated with a particular technology such as network connections, file system access, command line invocations, user privileges, etc. For example, attack procedure descriptions 102 pertaining to command line invocations may be selected. The resulting synthetic attack data 140 reflects attacks that invoke commands via the command line.

In some configurations, attack procedure descriptions 102 are integrated into prompt guideline generation prompt 104, which is provided to prompt guideline generation model 110. Prompt guideline generation prompt 104 may ask prompt guideline generation model 110 to generate prompt guideline 112 for managing how synthetic attack data generation model 130 operates. While prompt guideline generation model 110 is used to generate prompt guideline 112 in FIG. 1, non-ML based techniques for generating prompt guideline 112 are similarly contemplated.

In some configurations, prompt guideline 112 describes in natural language how synthetic attack data generation model 130 is to generate synthetic attack data 140. One example prompt guideline 112 generated for the example attack procedure listed above is:

```
- Include the use of macros to trigger the PowerShell script, specifically for downloading
  malware, to reflect the Wizard Spider's technique of leveraging macros for initial
  execution
- Ensure the PowerShell script includes commands for lateral movement across the
  network, such as using ‘Invoke-Command’ to execute commands on remote systems,
  reflecting the adversary's behavior of moving laterally through victim networks.
```

As can be seen, prompt guideline 112 is a generated prompt that may be used to instruct synthetic attack data generation model 130 how to generate synthetic attack data 140 based on the substance of attack procedure descriptions 102.

In some configurations, prompt guideline 112 is integrated with attack data samples 106 to yield synthetic attack data training prompt 120. Attack data samples 106 represent data generated from real-world attacks, such as event logs, event tables, or the like. Attack data samples 106 may include telemetry data captured by the victim computing device, for example. Below is a template of synthetic attack data training prompt 120 before being customized with prompt guideline 112 and attack data samples 106:

prompt_template = ″″″
{ {mitre_technique.background} }
Here are some example logs of a technique:
{ {example_logs} }
Now please output example logs for { {mitre_technique_name} } MITRE attack technique.
There should be at least one event row which is an Alert as well. The columns of the output
example logs should have exactly the same names as the input example logs. Only the
fields used in the logs are used in the detection logic itself. So for an Alert event, the logs
generated must have information that could be used to detect the attack. Logs should look
like a real attack, not like a pentester or unit test, and represent only one device's point of
view. The Follow the instructions exactly creating a log for { {mitre_technique_name} }.
Be creative in the variety of attack type logs you generate. The more realistic the better.

Attack data samples 106 may replace the “{{example_logs}}” text, among other substitutions that yield prompt 120. An example of prompt 120 is reproduced below:

```
MITRE ATT&CK Technique: Rootkit
Tactic: TA104
Description: Adversaries may use rootkits to hide the presence of programs, files, network
connections, services, drivers, and other system components. Rootkits are programs
designed to evade detection by masking their existence or the existence of other software.
Rootkits or rootkit enabling functionality may reside at the user or kernel level in the
operating system or lower, to include a hypervisor, Master Boot Record, or System
Firmware. Rootkits have been seen for Windows, Linux, and MacOS, and in firmware such
as BIOS, making detection extremely difficult.
Here are some example logs of a technique:
Entry
{
  “Time”: “2024-03-08 21:35:40”,
  “Process”: “C:\...\powershell.exe”,
  “Event”: “EIN-1101-AmsiScriptContent”,
  “Data”: {
    “InitiatingProcess:PARENT_PROCESS_IMAGE_ORIGINAL_NAME”: {
    “PropertyValue”: “C:\Windows\...\svchost.exe”
    }
  }
}
{
  “Time”: “2024-03-08 21:35:40”,
  “Process”: “C:\Windows\System32\reg.exe”,
  “Event”: “Alert”,
  “Data”: {
    “AlertTitle”: “Sensitive information lookup”,
  }
}
{
  “Time”: “2024-03-08 21:35:40”,
  “Process”: “C:\Windows\System32\reg.exe”,
  “Event”: “EIN-44-Unknown”,
  “Data”: {
    “ExtractedRegistryKey”: {
      “PropertyType”: 1,
      “PropertyValue”: “SECURITY”
    },
    “ExtractedUserAccount”: “SYSTEM”
  }
}
{
  “Time”: “2024-03-08 21:35:40”,
  “Process”: “C:\Windows\System32\reg.exe”,
  “Event”: “fileCreate”,
  “Data”: {
    “ActionType”: “FileCreated”,
    “FilePath”: “C:\Users\...\AppData\...\security”
  }
}
```

In this example, attack data samples 106 includes events extracted from an event log of a device that was targeted by a cyberattack. This real event log data gives context as to the expected format of the generated synthetic attack data 140.

The first event indicates that the powershell.exe process, a command line interface, was launched from svchost.exe. The next entry is an alert generated by reg.exe, indicating that a “sensitive information lookup” was performed. Next, reg.exe was invoked again to extract a registry key. Reg.exe was then invoked again to create a file.

Another example of a sequence of events indicative of an attack is: data collection in a password protected field, zipping all docs and excel spreadsheets into a password protected archive, an alert surfacing, followed by mass-delete of the source files.

The description portion of synthetic attack data training prompt 120 describes a technique used by attackers to compromise a system. In this case the technique is a rootkit. The events of attack data samples 106 may or may not be specific to the type of attack described by synthetic attack data training prompt 120.

Synthetic attack data generation model 130 receives synthetic attack data training prompt 120 and uses it to generate synthetic attack data 140. Synthetic attack data generation model 130 may be a large language model or other type of machine learning model. Synthetic attack data 140 may be formatted as log entries similar to the log entries of attack data samples 106. Additionally, or alternatively, synthetic attack data 140 may include one or more fields of the log entries without any of the other fields. For example, synthetic attack data 140 may include a target command launched via a command line process instead of an entire log entry representative of launching a command line process.

The generated events of synthetic attack data 140 mimic events that would be generated by a computing device when under attack. Examples of actions taken by a computing device that are recorded as events include opening a file, logging in as a particular user, launching a process, etc.

In some configurations the types of synthetic events vary, while in other configurations the types of synthetic events are focused or singular. For example, synthetic attack data generation model 130 may be configured to generate events that reflect interactions with a command line interface (CLI) such as PowerShell or bash.

One type of action often taken by attackers is to launch a command line process, passing a command to be executed as a parameter. Example commands include downloading a file, launching applications, accessing data, elevating permissions, or other actions exposed by the computing device. These commands may be logged in an event log of process launch events. The command passed to the command line may itself generate an event, in addition to launching the command line process. For example, a command line command to transfer a file may generate a file access event or a network connection event in addition to the process launch event.

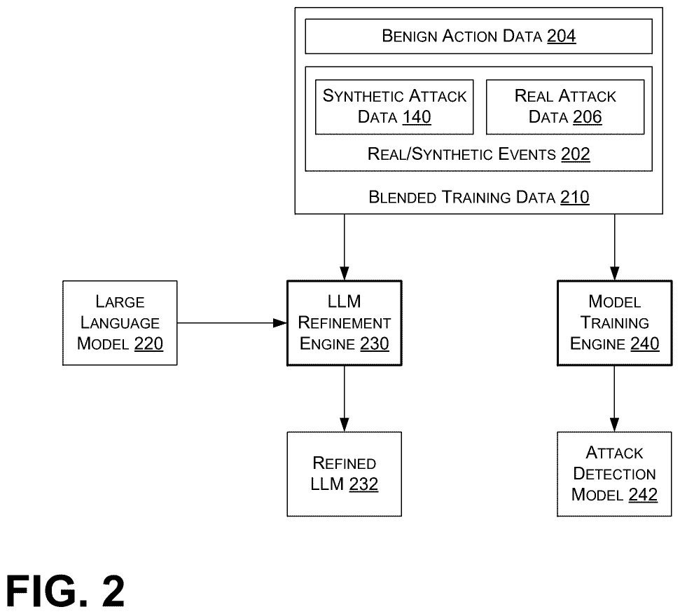

FIG. 2 illustrates training a machine learning model from synthetic and real attack data as well as benign action data. In some configurations, synthetic attack data 140 is blended with real attack data 206. This combination of real and synthetic events 202 may further be combined with benign action data 204, which includes events, event logs, or other indications of benign actions taken by a computing device. Collectively, this blended training data 210 is used by LLM refinement engine 230 to refine large language model 220 into refined LLM 232. Similarly, model training engine 240 may use blended training data 210 to train attack detection model 242.

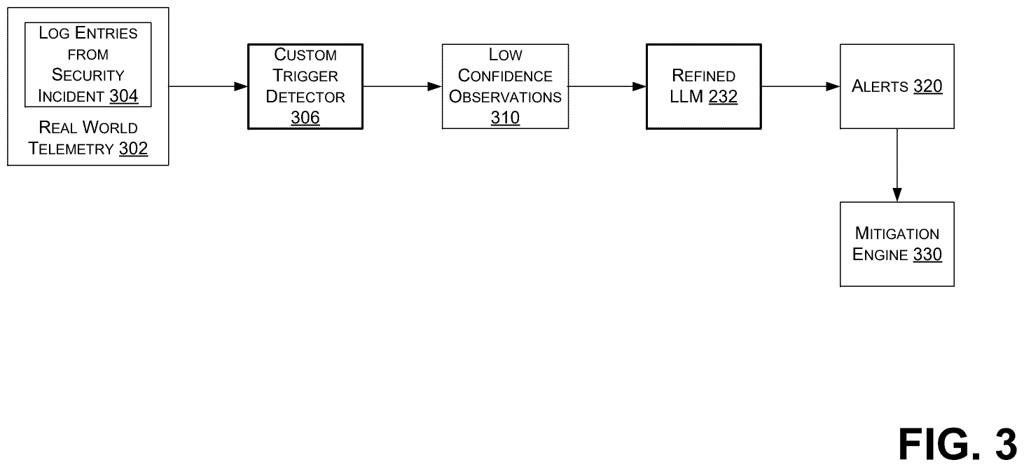

FIG. 3 illustrates generating an alert of a security incident. Custom trigger detector 306 may utilize a small parameter version of refined LLM 232 or attack detection model 242 to observe real world telemetry 302 in production systems. Custom trigger detector 306 may operate in real-time or near real-time to provisionally identify log entries from security incident 304 such as gaining unauthorized access to a computing resource, privilege escalation, a data breach, ransomware, or other nefarious usage. To do this, custom trigger detector 306 may observe events, event logs, or other indications of actions taken by one or more computing devices. Real-time analysis refers to analyzing events as they occur or are recorded by a computing device, while near real-time analysis refers to analyzing events within a defined period of time, such as processing events in batches every few minutes, Hours, or days.

Custom trigger detector 306 may pre-process this stream of events, de-duplicating events per device or per user. This may reduce duplicative processing of the same events on the same timelines. In some configurations, event fields beyond a defined length are truncated. Another pre-processing step filters out all but the most valuable fields of the events, increasing the effectiveness of LLMs with small context windows.

Once pre-processed, the remaining events and other information may be provided to refined LLM 232 or attack detection model 242 to infer whether an attack is in progress. Custom trigger detector 306 may operate on premise or on device, and is designed to balance the need for comprehensive and accurate detection with constraints on power consumption and resource utilization.

Custom trigger detector 306, which may use a low-parameter version of refined LLM 232 or attack detection model 242, generates low confidence observations 310 from event information. Low confidence observations 310, including the event information that triggered them, may then be provided to full parameter versions of refined LLM 232 and/or attack detection model 242. Full parameter versions of refined LLM 232 and/or attack detection model 242 may run on a different computing device. Full parameter versions of refined LLM 232 and/or attack detection model 242 are used to generate alerts 320, indicating to relevant parties than an attack may be in process.

In some configurations, alerts 320 are provided to mitigation engine 330 to determine a technique to halt, reverse, or otherwise mitigate the effect of the security incident 304. Mitigation engine 330 may use a machine learning model to generate suggested courses of action based on the severity of the attack. In some configurations, such as when the severity of the attack is large and the effects are irreversible, mitigation engine 330 may automatically perform a mitigation procedure that targets security incident 304.

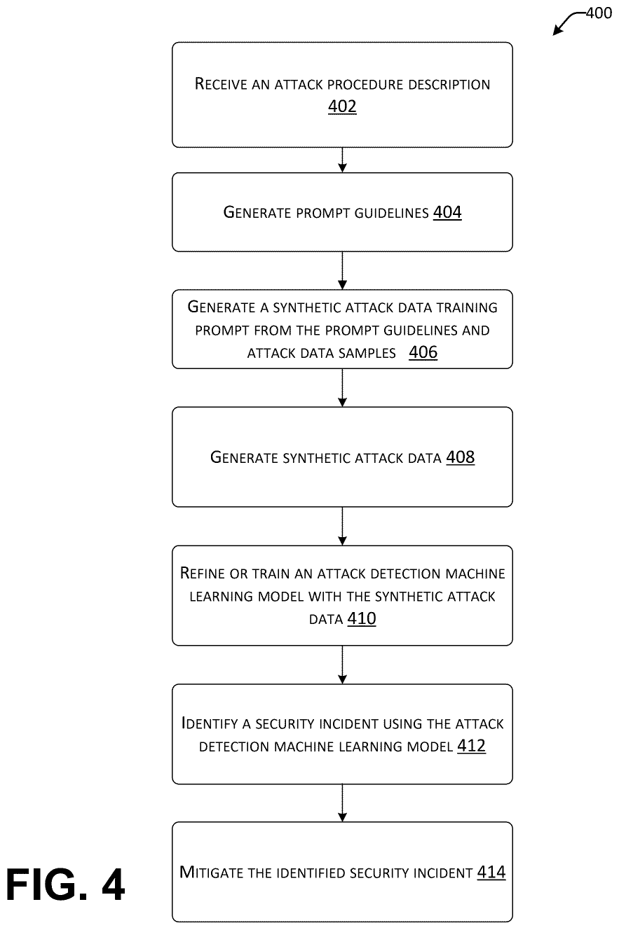

FIG. 4 is a flow diagram of an example method for a large language model generated endpoint detection and response system. Routine 400 begins at operation 402, where an attack procedure description 102, such as a security-related blog post, is received.

Next at operation 404, prompt guidelines 112 are generated by prompt guideline generation model 110 from attack procedure descriptions 102 and prompt guideline generation prompt 104.

Next at operation 406, synthetic attack data training prompt 120 is generated from synthetic guidelines 112 and attack data samples 106.

Next at operation 408, synthetic attack data 140 is generated by synthetic attack data generation model 130 based on synthetic attack data training prompt 120.

Next at operation 410, LLM 220 is refined into refined LLM 232 using blended training data 210 that includes at least synthetic attack data 140 and which may optionally include real attack data 206 and/or benign action data 204. Additionally, or alternatively, blended training data 210 is used by model training engine 240 to generate attack detection model 242.

Next, at operation 412, security incident 304 is identified using refined LLM 232 and/or attack detection model 242.

Next, at operation 414, the identified security incident 304 is mitigated by mitigation engine 330.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 500 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 400 may be also implemented in many other ways. For example, the routine 400 may be implemented, at least in part, by a processor of another remote computer or a local circuit. In addition, one or more of the operations of the routine 400 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

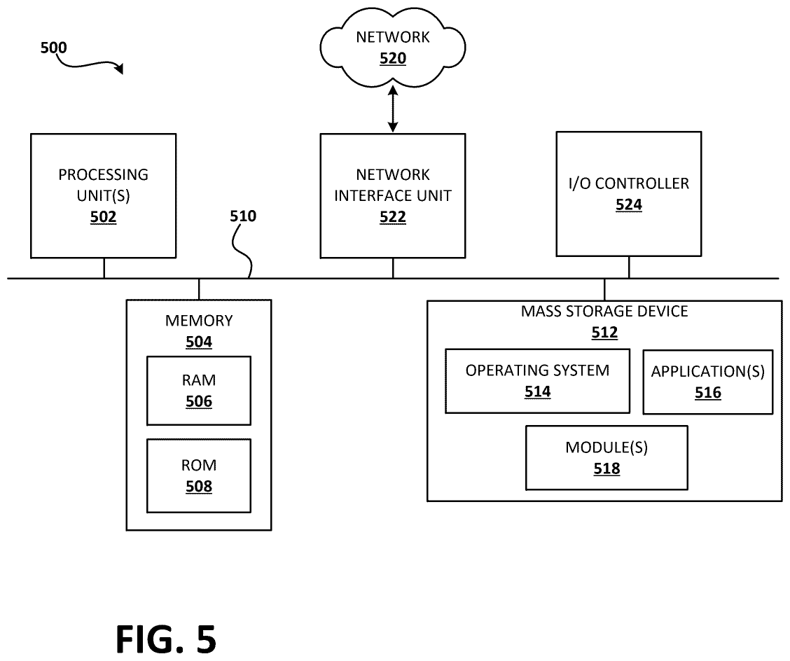

FIG. 5 shows additional details of an example computer architecture 500 for a device, such as a computer or a server configured as part of the systems described herein, capable of executing computer instructions (e.g., a module or a program component described herein). The computer architecture 500 illustrated in FIG. 5 includes processing unit(s) 502, a system memory 504, including a random-access memory 506 (“RAM”) and a read-only memory (“ROM”) 508, and a system bus 510 that couples the memory 504 to the processing unit(s) 502.

Processing unit(s), such as processing unit(s) 502, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518, and other data described herein.

The mass storage device 512 is connected to processing unit(s) 502 through a mass storage controller connected to the bus 510. The mass storage device 512 and its associated computer-readable media provide non-volatile storage for the computer architecture 500. Although the description of computer-readable media contained herein refers to a mass storage device, it should be appreciated by those skilled in the art that computer-readable media can be any available computer-readable storage media or communication media that can be accessed by the computer architecture 500.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

It should be appreciated that the software components described herein may, when loaded into the processing unit(s) 502 and executed, transform the processing unit(s) 502 and the overall computer architecture 500 from a general-purpose computing system into a special-purpose computing system customized to facilitate the functionality presented herein. The processing unit(s) 502 may be constructed from any number of transistors or other discrete circuit elements, which may individually or collectively assume any number of states. More specifically, the processing unit(s) 502 may operate as a finite-state machine, in response to executable instructions contained within the software modules disclosed herein. These computer-executable instructions may transform the processing unit(s) 502 by specifying how the processing unit(s) 502 transition between states, thereby transforming the transistors or other discrete hardware elements constituting the processing unit(s) 502.

The present disclosure is supplemented by the following example clauses:
Example 1: A method comprising: receiving an attack procedure description; generating a prompt guideline from the attack procedure description; generating a synthetic attack data training prompt from the prompt guideline and an attack data sample; generating, with the synthetic attack data training prompt, synthetic attack data; training an attack detection machine learning model with the synthetic attack data; identifying a security incident with the attack detection machine learning model; and mitigating the security incident.
Example 2: The method of Example 1, wherein the attack detection machine learning model is trained with benign action data that indicates operations taken on a computing device during a benign interaction.
Example 3: The method of Example 1, wherein generating synthetic attack data comprises generating log entries that mimic real-world attack data.
Example 4: The method of Example 1, wherein training the attack detection machine learning model comprises refining an existing large language model.
Example 5: The method of Example 1, wherein the prompt guideline comprises samples of actual attack data.
Example 6: The method of Example 5, wherein the synthetic attack data is formatted based on the samples of actual attack data.
Example 7: The method of Example 1, wherein the prompt guideline is generated in part with a prompt guideline generation model.
Example 8: A computer-readable storage medium having computer-executable instructions stored thereupon that, when executed by a processing system, cause the processing system to:
receive an attack procedure description; generate a synthetic attack data training prompt from the attack procedure description and an attack data sample; generate, with the synthetic attack data training prompt, synthetic attack data; train an attack detection machine learning model with the synthetic attack data; identify a security incident with the attack detection machine learning model; and mitigate the identified security incident.
Example 9: The computer-readable storage medium of Example 8, wherein the synthetic attack data training prompt is generated based on a prompt guideline that is derived from the attack data sample.
Example 10: The computer-readable storage medium of Example 8, wherein the prompt guideline includes samples of actual attack data.
Example 11: The computer-readable storage medium of Example 8, the attack data sample comprises an event from an event log.
Example 12: The computer-readable storage medium of Example 8, wherein the attack detection machine learning model is trained on real attack data:
Example 13: The computer-readable storage medium of Example 8, wherein the attack detection machine learning model is trained on benign action data.
Example 14: A system comprising: a processor; a memory storing instructions that, when executed by the processor, cause the system to perform operations comprising: receiving an attack procedure description; generating a prompt guideline from the attack procedure description; generating a synthetic attack data training prompt from the prompt guideline and an attack data sample; generating, with the synthetic attack data training prompt, synthetic attack data; training an attack detection machine learning model with the synthetic attack data; identifying a security incident with the attack detection machine learning model; and mitigating the security incident
Example 15: The system of Example 14, wherein the prompt guideline is generated by a prompt guideline generation model.
Example 16: The system of Example 15, wherein the prompt guideline generation model infers the prompt guideline from a prompt generation guideline prompt and the attack procedure description.
Example 17: The system of Example 14, wherein the synthetic attack data is inferred from the synthetic attack data training prompt by a synthetic attack data generation model.
Example 18: The system of Example 14, wherein the security incident is provisionally identified by identifying a log entry with a low-parameter version of the attack detection model.
Example 19: The system of Example 18, wherein a refined version of the attack detection model confirms that the provisionally identified security incident is an actual security incident.
Example 20: The system of Example 14, wherein the security incident is mitigated by providing the alert to a large language model as part of a prompt for a mitigation procedure and executing the mitigation procedure.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving an attack procedure description;
generating a prompt guideline from the attack procedure description;
generating a synthetic attack data training prompt from the prompt guideline and an attack data sample;
generating, with the synthetic attack data training prompt, synthetic attack data;
training an attack detection machine learning model with the synthetic attack data;
identifying a security incident with the attack detection machine learning model; and
mitigating the security incident.

2. The method of claim 1, wherein the attack detection machine learning model is trained with benign action data that indicates operations taken on a computing device during a benign interaction.

3. The method of claim 1, wherein generating synthetic attack data comprises generating log entries that mimic real-world attack data.

4. The method of claim 1, wherein training the attack detection machine learning model comprises refining an existing large language model.

5. The method of claim 1, wherein the prompt guideline comprises samples of actual attack data.

6. The method of claim 5, wherein the synthetic attack data is formatted based on the samples of actual attack data.

7. The method of claim 1, wherein the prompt guideline is generated in part with a prompt guideline generation model.

8. A computer-readable storage medium having computer-executable instructions stored thereupon that, when executed by a processing system, cause the processing system to:
receive an attack procedure description;
generate a synthetic attack data training prompt from the attack procedure description and an attack data sample;
generate, with the synthetic attack data training prompt, synthetic attack data;
train an attack detection machine learning model with the synthetic attack data;
identify a security incident with the attack detection machine learning model; and
mitigate the identified security incident.

9. The computer-readable storage medium of claim 8, wherein the synthetic attack data training prompt is generated based on a prompt guideline that is derived from the attack data sample.

10. The computer-readable storage medium of claim 8, wherein the prompt guideline includes samples of actual attack data.

11. The computer-readable storage medium of claim 8, the attack data sample comprises an event from an event log.

12. The computer-readable storage medium of claim 8, wherein the attack detection machine learning model is trained on real attack data.

13. The computer-readable storage medium of claim 8, wherein the attack detection machine learning model is trained on benign action data.

14. A system comprising:
a processor;
a memory storing instructions that, when executed by the processor, cause the system to perform operations comprising:
receiving an attack procedure description;
generating a prompt guideline from the attack procedure description;
generating a synthetic attack data training prompt from the prompt guideline and an attack data sample;
generating, with the synthetic attack data training prompt, synthetic attack data;
training an attack detection machine learning model with the synthetic attack data;
identifying a security incident with the attack detection machine learning model; and
mitigating the security incident.

15. The system of claim 14, wherein the prompt guideline is generated by a prompt guideline generation model.

16. The system of claim 15, wherein the prompt guideline generation model infers the prompt guideline from a prompt generation guideline prompt and the attack procedure description.

17. The system of claim 14, wherein the synthetic attack data is inferred from the synthetic attack data training prompt by a synthetic attack data generation model.

18. The system of claim 14, wherein the security incident is provisionally identified by identifying a log entry with a low-parameter version of the attack detection model.

19. The system of claim 18, wherein a refined version of the attack detection model confirms that the provisionally identified security incident is an actual security incident.

20. The system of claim 14, wherein the security incident is mitigated by providing the alert to a large language model as part of a prompt for a mitigation procedure and executing the mitigation procedure.
